(19) United States
(12) Patent Application Publication
(10) Pub. No.: US 2026/0302929 A1
(43) Pub. Date: Oct. 1, 2026

(54) CHOPPER CIRCUIT

(71) Applicants: TAMURA CORPORATION, Toyko (JP); TOHOKU UNIVERSITY, Miyagi (JP)

(72) Inventors: Kuniaki HATTORI, Tokyo (JP); Tsutomu HAMADA, Tokyo (JP); Yoshikazu TAKAHASHI, Miyagi (JP); Naoki TAKAGI, Miyagi (JP)

(73) Assignees: TAMURA CORPORATION, Toyko (JP); TOHOKU UNIVERSITY, Miyagi (JP)

(21) Appl. No.: 19/570,547

(22) Filed: Mar. 18, 2026

(30) Foreign Application Priority Data
Mar. 31, 2025 (JP) 2025-058738

(51) Int. Cl. H02M 1/14; H02M 1/00; H02M 3/156

(52) U.S. Cl. CPC H02M 1/143; H02M 1/0058; H02M 3/156

(57) ABSTRACT

To obtain a chopper circuit that can reduce a loss of the circuit. The chopper circuit 10 includes the switching element 2 and the reactor 3. A low load current flowing through the reactor 3 and a high load current having a current value higher than that of the low load current both have, within one cycle, a section that flows in a negative direction. The switching element 2 performs soft switching both at the time of the low load current and at the time of the high load current. The ripple current Δi_{L} at the time of the low load current is controlled to become smaller than the ripple current Δi_{H} at the time of the high load current.

### CROSS-REFERENCE TO RELATED APPLICATION

This application is based upon and claims the benefit of priority from Japanese Patent Application No. 2025-058738, filed on Mar 31, 2025, the entire contents of which are incorporated herein by reference.

### FIELD OF INVENTION

The present disclosure relates to a chopper circuit that performs soft switching.

### BACKGROUND

A chopper circuit is known as a circuit that chops a current or a voltage by turning a switch ON and OFF and converts it into a current or a voltage of another magnitude. A reactor is mounted in this chopper circuit. In general, it is said that, as for an inductance value of the reactor, it is possible to suppress a ripple current by maintaining a high inductance value not only at the time of a low load current but also at the time of a high load current in which an average value of the current is larger than an average value of the low load current. That is, a method of keeping a high inductance value constant from a low load current to a high load current has been performed (see FIG. 4).

Also, a switching method for turning a switching element ON and OFF is known, and, for example, a soft switching method can be mentioned. When soft switching is performed both at the time of a low load current and at the time of a high load current, it is necessary to cause a negative current to flow from the time of the low load current to the time of the high load current. In order to cause the negative current to flow from the time of the low load current to the time of the high load current, an inductance value of the reactor is kept constant at a low value (see FIG. 6).

### PROBLEMS TO BE SOLVED BY INVENTION

However, when an inductance value is kept constant, a ripple current in a low load current region and a ripple current in a high load current region become substantially the same. That is, when an inductance value of a reactor is maintained constant at a low value, a current waveform at the time of a low load current enters too much into a negative side, and a ripple current at the time of the low load current becomes large. When the ripple current becomes large, a loss of the circuit also increases.

The present disclosure is achieved to address the above-described problem, and an object thereof is to provide a chopper circuit that can reduce a loss of the circuit.

### SUMMARY OF INVENTION

A chopper circuit of the present disclosure includes; a switching element and a reactor, in which a low load current and a high load current whose average value of current is higher than an average value of the low load current, which flow through the reactor, both have, within one cycle, a section that flows in a negative direction, the switching element performs soft switching both at the time of the low load current and at the time of the high load current, and a ripple current at the time of the low load current is controlled to become smaller than a ripple current at the time of the high load current.

According to the present disclosure, it is possible to obtain a chopper circuit that can reduce a loss of the circuit.

### BRIEF DESCRIPTION OF DRAWINGS

FIG. 1 is a circuit diagram of a chopper circuit of a soft switching method according to the present embodiment.

FIG. 2 is a graph showing current waveforms of a reactor at the time of a low load current and at the time of a high load current.

FIG. 3 is a graph showing an inductance value of a reactor under superposition characteristics.

FIG. 4 is a graph showing superposition characteristics of a general reactor.

FIG. 5 is a graph showing a current waveform of a reactor that maintains superposition characteristics of high inductance from the time of a low load current to the time of a high load current.

FIG. 6 is a graph showing superposition characteristics of a conventional reactor that performs soft switching at the time of a low load current and at the time of a high load current.

FIG. 7 is a graph showing a current waveform of a reactor that maintains superposition characteristics of low inductance from the time of a low load current to the time of a high load current.

### DETAILED DESCRIPTION OF THE EMBODIMENTS

### Embodiment

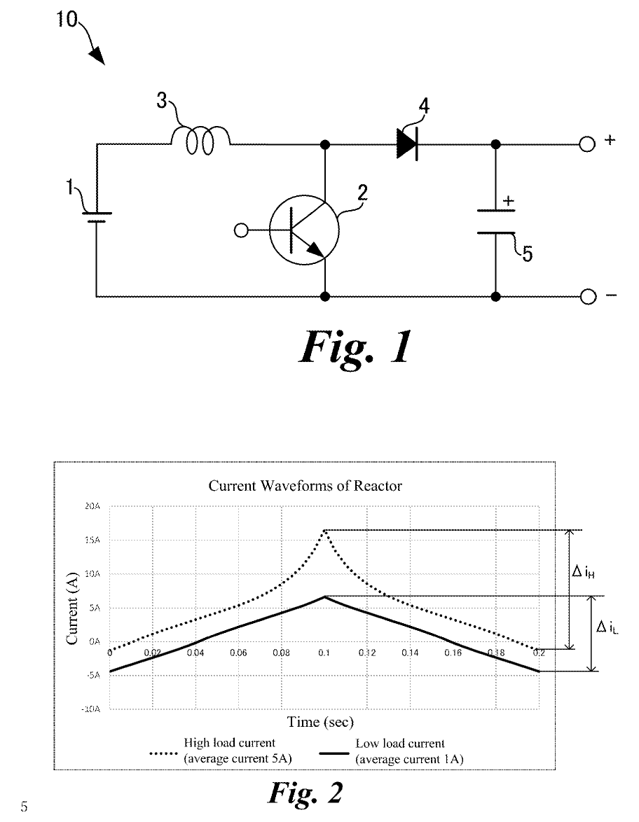

A chopper circuit according to an embodiment will be described with reference to the figures. FIG. 1 is a circuit diagram of the chopper circuit of a soft switching method according to the present embodiment.

The chopper circuit is a circuit that chops a current or a voltage by turning a switch ON and OFF and converts it into a current or a voltage of another magnitude. Also, as a conversion method by the chopper circuit 10, for example, there is a soft switching method. The chopper circuit 10 is provided with a DC power supply 1, a switching element 2, a reactor 3, a diode 4, and a capacitor 5.

The DC power supply 1 is a member for supplying a stable DC voltage or current. A positive electrode of the DC power supply 1 is connected in series to the reactor 3. A negative electrode of the DC power supply 1 is connected to the switching element 2 and a negative electrode of the capacitor 5.

The switching element 2 is a semiconductor element that turns ON or OFF a current flowing through the circuit. The switching element 2 is connected to the reactor 3 and an anode of the diode 4. The switching element 2 turns ON and OFF a switch element. The switching element 2 performs soft switching.

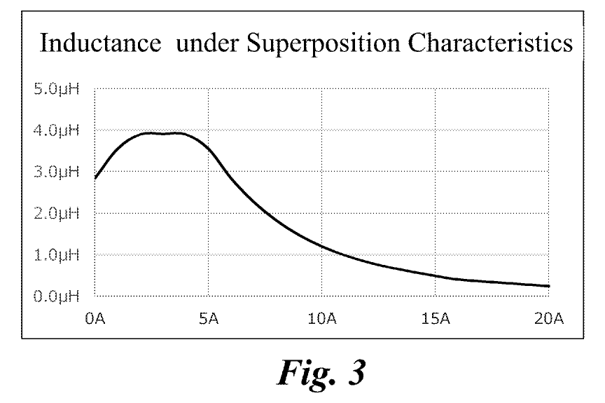

The switching element 2 performs soft switching both for a low load current and for a high load current in which an average value of the current is higher than an average value of the low load current. The low load current and the high load current can be defined as follows. In an inductance value (see FIG. 3) under superposition characteristics of the reactor 3, which will be described later, when a maximum inductance value at which an inductance value becomes maximum is defined as LMAX and an arbitrary inductance value is defined as L, a current at which L/LMAX becomes 0.1 is defined as a maximum average current. The maximum average current indicates a current at which an inductance approaches saturation. Then, a current having an average value of less than one half of the maximum average current is referred to as a low load current, and a current having an average value of one half or more of the maximum average current is referred to as a high load current. Note that the average current or the average value of the current means, in a current waveform, a current obtained by averaging a current over one cycle.

Also, unlike the definition based on the maximum average current described above, a boundary between the low load current and the high load current may be based on 4 A as an average value of the current. That is, it is preferable that an average value of the low load current is a current of less than 4 A and an average value of the high load current is a current of 4 A or more. In the following, the low load current will be described as a current whose average value is less than 4 A, and the high load current will be described as a current whose average value is 4 A or more; however, the boundary between the low load current and the high load current is not limited to 4 A.

The reactor 3 is an electromagnetic component that converts electric energy into magnetic energy for accumulation and release. More specifically, in accordance with ON and OFF of the switching element 2, the reactor 3 repeatedly stores and releases magnetic energy converted from electrical energy, thereby enabling step-up or step-down in the chopper circuit 10. The reactor 3 is connected to the DC power supply 1 and a positive electrode of the capacitor 5. The reactor 3 includes a core and a coil.

The core is made of a magnetic material. The coil is mounted on the core. Lead wires are drawn out from the coil, and the lead wires are electrically connected to an external device including a circuit board. When electric power is supplied from the external device to the coil, the coil generates magnetic flux. The core serves as a closed magnetic path through which the magnetic flux generated by the coil passes.

FIG. 2 is a graph showing current waveforms of the reactor 3 at the time of a low load current and at the time of a high load current. As shown in FIG. 2, the reactor 3 has a region in which a current is below 0 A at the time of a low load current and at the time of a high load current.

Also, the reactor 3 is adjusted so that a ripple current Δi_{L} at the time of a low load current becomes smaller than a ripple current Δi_{H} of a high load current. In the present embodiment, by adjusting an inductance value of the reactor 3 under superposition characteristics, the ripple current Δi_{L} at the time of the low load current is made smaller than the ripple current Δi_{H} at the time of the high load current.

FIG. 3 is a graph showing an inductance value of the reactor 3 under superposition characteristics. As shown in FIG. 3, an inductance value of the reactor 3 is not constant but draws a curve that drops steeply at the time of a high load current. More specifically, in a low load current region in which an average value of the current is less than 4 A, a high inductance value is maintained, and, in a high load current region in which an average value of the current is 4 A or more, the inductance value is steeply decreased.

As a steep decrease rate of the inductance value, it is preferable that, compared with the inductance value L at the time when the maximum average current is one half, the inductance value L at the time of the maximum average current becomes 50% or less. That is, it is preferable that (the inductance value at the time of the maximum average current)/ (the inductance value at the time when the maximum average current is one half) is 0.5 or less. By setting the decrease rate to 50% or less, even in a high load current, it is possible to cause a negative current to flow and to perform soft switching, and it is also possible to reduce a ripple current at the time of a low load current. Note that the decrease rate is preferably 5% or more. When the inductance decreases more steeply than 5%, the ripple current becomes unnecessarily large, and a loss of the chopper circuit 10 increases.

Also, it is preferable that, as for an inductance value at the time of a current that is twice the maximum average current, a decrease rate is set to 50% or less as compared with an inductance value at the time of the maximum average current. When the graph of FIG. 2 is viewed, a current waveform of the high load current has a slope that becomes steeply larger from about 10 A. For example, when the inductance value is steeply decreased at a point of 5 A, which is immediately after entering a region of the high load current, as shown in FIG. 2, a slope of a region portion in which the low load current also exceeds 5 A becomes larger, and the ripple current Δi_{L} at the time of the low load current becomes large.

The diode 4 is a semiconductor element that allows a current to flow in a fixed direction. An anode of the diode 4 is connected to the switching element 2 and the reactor 3, and a cathode of the diode 4 is connected to a positive electrode of the capacitor 5.

The capacitor 5 is an electronic component that stores and releases electricity. The positive electrode of the capacitor 5 is connected to the cathode of the diode 4, and a negative electrode of the capacitor 5 is connected to the DC power supply 1 and the switching element 2.

### Effect

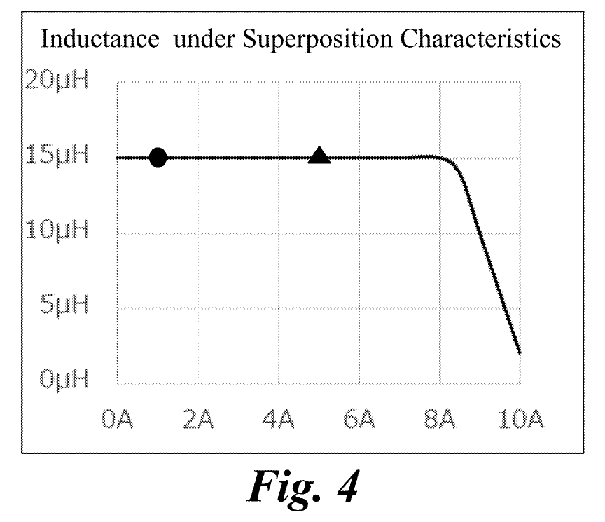

A relationship between superposition characteristics of inductance of the reactor 3 and a current waveform of the reactor 3 will be described in detail. FIG. 4 is a graph showing superposition characteristics of a general reactor. As shown in FIG. 4, in general, a reactor that keeps a high value constant from the time of a low load current to the time of a high load current is considered good. In other words, a reactor in which an inductance value decreases immediately when a current is increased is evaluated as having poor magnetic characteristics.

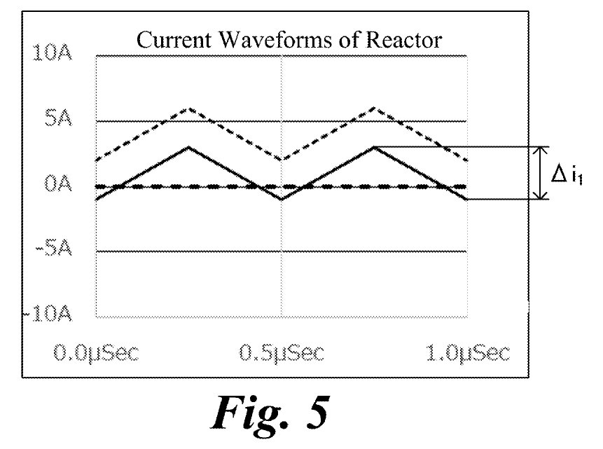

FIG. 5 is a graph showing a current waveform of a reactor that maintains superposition characteristics of high inductance from the time of a low load current to the time of a high load current. In FIG. 5, a solid line shows a waveform at the time of a low load current whose average value is 1 A (a black circle mark in FIG. 4), and a dotted line shows a waveform at the time of a high load current whose average value is 5 A (a black triangle mark in FIG. 4). As shown in FIG. 5, at the time of the low load current, there is a region that reaches a position below 0 A, but, at the time of the high load current, there is no region that reaches a position below 0 A. Therefore, in this reactor, it is not possible to perform soft switching at the time of the high load current.

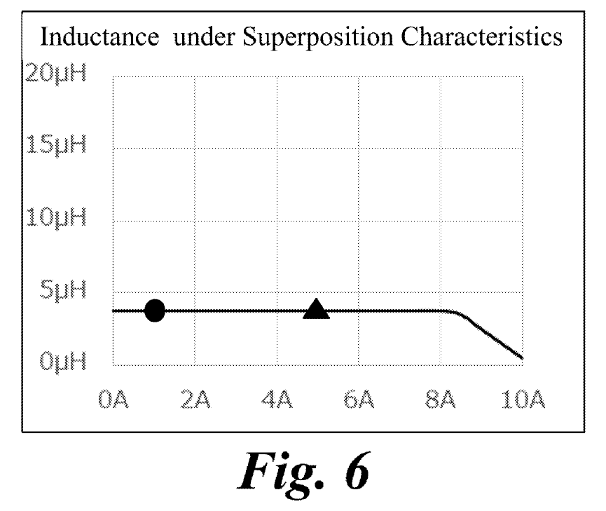

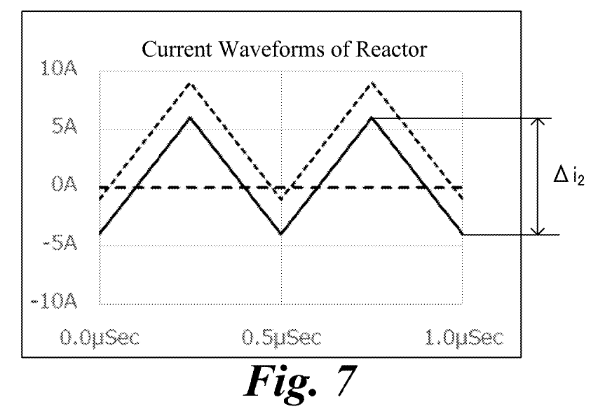

In order to cause a current below 0 A to flow at the time of a high load current, it is necessary to reduce an inductance value under superposition characteristics. FIG. 6 is a graph showing superposition characteristics of a conventional reactor that performs soft switching from the time of a low load current to the time of a high load current. As shown in FIG. 6, the conventional reactor keeps an inductance value under superposition characteristics constant at a low value.

FIG. 7 is a graph showing a current waveform of a reactor that maintains superposition characteristics of low inductance from the time of a low load current to the time of a high load current. Note that solid and dotted lines in FIG. 7 are the same as those in FIG. 5, the solid line showing a waveform at the time of a low load current, and the dotted line showing a waveform of at the time of a high load current. As shown in FIG. 7, even at the time of the high load current, a current below 0 A is generated, and it becomes possible to perform soft switching not only at the time of the low load current but also at the time of the high load current. However, a current flowing to a negative side at the time of the low load current also becomes large. Therefore, a ripple current Δi₂ at the time of the low load current becomes larger than a ripple current Δi₁ at the time of the low load current shown in FIG. 5. Therefore, a loss as the chopper circuit increases.

Accordingly, as shown in FIG. 2, in the chopper circuit of the present disclosure, the reactor 3 is controlled so that a ripple current Δi_{L} at the time of a low load current becomes smaller than a ripple current Δi_{H} at the time of a high load current. Accordingly, it is possible to suppress an increase in the ripple current at the time of the low load current, to perform switching from the time of the low load current to the time of the high load current, and to reduce a loss of the chopper circuit 10.

In particular, in the present embodiment, as shown in FIG. 3, an inductance value of the reactor 3 under superposition characteristics is controlled to maintain a high value at the time of a low load current and to become low at the time of a high load current. Accordingly, without using an auxiliary circuit or the like, it is possible to suppress the ripple current while performing soft switching both at the time of the low load current and at the time of the high load current, to reduce the number of components, and to reduce manufacturing cost and a size of the chopper circuit 10.

### Other Embodiment

In the description herein, although embodiments according to the present disclosure are described, said embodiments are only provided as examples and are not intended to limit the scope of claims. The above-described embodiments may be implemented by other various forms, and various omissions, replacements, and changes may be made without departing from the scope of claims. The embodiments and modifications thereof are included in the invention described in the claims and equivalent ranges thereto, as well as in the scope and abstract of the invention.

In the above embodiment, the chopper circuit 10 is of a step-up type; however, the chopper circuit 10 is not limited to this. The chopper circuit 10 may be of a step-down type, or may be of a step-up/down type.

### REFERENCE SIGN

10: chopper circuit

1: DC power supply

2: switching element

3: reactor

4: diode

5: capacitor

What is claimed is:

1. A chopper circuit comprising:
a switching element and a reactor,
wherein a low load current and a high load current whose average value of current is higher than an average value of the low load current, which flow through the reactor, both have, within one cycle, a section that flows in a negative direction,
the switching element performs soft switching both at the time of the low load current and at the time of the high load current, and
a ripple current at the time of the low load current is controlled to become smaller than a ripple current at the time of the high load current.

2. A chopper circuit according to claim 1,
wherein, by adjusting an inductance value in superposition characteristics of the reactor, the ripple current at the time of the low load current is controlled to become smaller than the ripple current at the time of the high load current.

3. A chopper circuit according to claim 2,
wherein the inductance value at the time of the high load current is lower than the inductance value at the time of the low load current.

4. A chopper circuit according to claim 1,
wherein, in an inductance value under superposition characteristics of the reactor, when a maximum inductance value at which an inductance value becomes maximum is LMAX and an arbitrary inductance value is L, a current at which L/LMAX becomes 0.1 is a maximum average current, a current having an average value of less than one half of the maximum average current is the low load current, and a current having an average value of one half or more of the maximum average current is the high load current.

5. A chopper circuit according to claim 1,
wherein an average value of the low load current is a current of less than 4 A, and
an average value of the high load current is a current of 4 A or more.
